(19) United States
(12) Patent Application Publication
(10) Pub. No.: US 2012/0120230 A1
(43) Pub. Date: May 17, 2012

(54) Apparatus and Method for Small Scale Wind Mapping

(75) Inventors: Thomas Wilkerson, Richmond, UT (US); Alan B. Marchant, Hyrum, UT (US); William James Bradford, Logan, UT (US); Michael Wojcik, Mendon, UT (US)

(73) Assignee: Utah State University, North Logan, UT (US)

(21) Appl. No.: 12/948,003

(22) Filed: Nov. 17, 2010

(51) Int. Cl. G06K 9/00; H04N 7/18; B64B 1/40; G01C 3/08; G01W 1/00

(52) U.S. Cl. 348/135; 356/4.01; 702/3; 382/103; 348/E07.085

(57) ABSTRACT

An apparatus and method for wind profiling using a lighter than air tracer balloon moving under the influence of air currents. A retroreflective target is attached to the tracer balloon to improve the intensity of a return signal reflected back to the rangefinder. After the balloon is released, the rangefinder and attitude sensor are used to measure the range and direction angles of the retroreflective target on the tracer balloon at periodic time intervals. The recorded trajectory data are processed by a computer program using data smoothing and filtering techniques to calculate the wind velocity components, horizontal wind speed and direction, and an estimate of wind shear,

### FIELD OF THE INVENTION

This invention relates to a method for mapping wind profiles as functions of time and the geographical coordinates and in particular to a method for measuring the position of a lighter than air balloon under the influence of air currents.

### BACKGROUND OF THE INVENTION

Wind profiling and wind measurement systems are important for a wide range of applications including wind farm prospecting and micrositing, calibration and validation of remote sensors, wind loading studies, air pollution studies, airborne recreations, airdrops of personnel and supplies, and predictions of the motion of hazardous releases. Wind profiling supports the development, installation, and operation of wind turbines by identifying favorable wind energy sites, characterizing dynamic changes and diurnal patterns in the wind field, optimizing wind turbine locations with respect to local wind conditions, and identifying interactions between turbines in an existing facility. Wind-field characterization is important in civil and environmental engineering because wind flow and variability affect the loading and stability of structures, the dispersion of potential pollutants, and the risks associated with hazardous releases into the atmosphere. Although computer models of wind flow have greatly improved in recent years, actual data collected on site is critical for accurate wind profiling.

Wind profiling ideally measures three dimensional (3D) wind velocities, both horizontally and vertically, over a wide area, with data updated over short time intervals. For example, wind-farm characterization calls for measurements up to an altitude of 500 meters with an altitude resolution of 20 meters, Horizontal resolution should also be on the order 20 m over a site typically having a 1 km diameter. Precision and accuracy of the wind velocity measurements should be better than 1 m/s, Wind energy applications require accuracy at high wind speeds, while low-speed accuracy is particularly important for environmental studies.

Existing methods for wind measurements are anemometers, sodar, Doppler lidar, tether sonde, and weather balloons. A major drawback of anemometers is that they provide only point measurements of wind speed at the fixed location of the sensor. Thus they cannot ordinarily provide either detailed wind profiles very far above ground or the characterization of wind patterns over an extended site. An obvious counter argument to this is the use of very tall, fixed towers to operate anemometers at the typical heights of wind turbines; indeed, long term data from such towers is often required for selecting suitable turbine sites. However, the very cost of installing of such tower is often prohibitive in the face of uncertain wind projections and the risk of failure due to uninformed tower placement. The need is great for indicative, affordable wind measurements such as are made possible using the system described in this patent application.

Soder and Lidar systems are remote sensors that can be used to survey wind velocities over an entire site throughout a large atmospheric volume. The principle drawbacks to Soder and wind Lidar are the relatively high cost, complexity, and the mean time between failures of the systems and the difficulty of installing or relocating them. Both Soder and Lidar have limitations with regard to true 3D wind characterization. In addition, Soder systems primarily provide measurements of mean wind, and parameters such as wind speed standard deviation, wind direction standard deviation, and wind gust, are usually either not available or not reliable with sodars.

The prior art for wind characterization includes the use of an airborne balloon or sonde as a wind tracer. The balloon is tracked and the wind field is inferred from the balloon velocity along its trajectory. Current pilot balloon tracking methods include:
1) Radar tracking of radiosondes. The radiosonde is a large, 1 to 2 meter diameter metalized balloon that is tracked by radar, usually to altitudes above the Troposphere. The surface of the radiosonde may be intentionally roughened to minimize lift instabilities that disturb the radiosonde trajectory.
2) GPS-outfitted radiosondes. A GPS receiver and transmitter may be suspended from the radiosonde, eliminating the need for radar tracking. The GPS payload does not significantly increase the cost of the radiosonde, because the large balloons are expensive to purchase and to launch.
3) Pilot Balloon (PIBAL). PIBAL balloons are tracked passively using a theodolite that measures the direction (azimuth and elevation angles) from the launch site to the balloon as a function of time. Altitude is usually calculated from pressure sensor telemetry and modeled atmospheric pressure profiles. Alternatively, altitude may be measured using synchronized observations from a second theodolite. For night-time observation, a PIBAL may be outfitted with a suspended light.

The prior art systems and methods for wind characterization using balloons share the following intrinsic deficiencies. Firstly, the radiosonde balloons are expensive; consequently they are restricted to applications such as weather monitoring where infrequent wind profiles are acceptable. Secondly, because of factors (such as size) to be explained herein, the balloons are susceptible to lift instabilities that degrade the wind measurement accuracy. Lift instabilities are induced motions associated with flow over the surface of an object and occur as a result of the drag and lift forces. The drag coefficient is small for a spherical balloon at high Reynolds number and the drag coefficient is large at a small Reynolds number. The nature of the flow separation from a surface is very different at a small Reynolds number compared to a large Reynolds number, and thus the flow separation process, which influences the drag and lift forces, can induce extraneous motions. Such motion instabilities occur when the Reynolds number is approximately 300,000 or larger. The Reynolds number is defined as R=ρvD/η, where ρ is the air density, v is the balloon rate of rise, D is the balloon diameter, and η is the air viscosity. For a 1 meter diameter radiosonde rising at 10 m/s, R=700,000, thus size and the associated lift instabilities induce balloon motions that contribute to inaccurate wind measurements. Other difficulties with the above sensor systems are the relative awkwardness of theodolite measurements, the cost of accurate radar systems, and the material “footprint” of balloons and payloads sent into the environment without recovery. These factors are minimized with the system described herein.

Therefore an inexpensive, easily deployable, real time, accurate, precise, and portable method, capable of three dimensional remote measurements of wind direction and velocity as a function of altitude, is needed for improved wind profiling.

### SUMMARY OF THE INVENTION

The wind profiling method and apparatus disclosed herein arises from innovations in a) laser tracking for accurate 3D positions, b) optical enhancement of the sensor, c) automated target tracking, and d) nonlinear trajectory analysis. The system utilizes a laser rangefinder to track the distance from a fixed sensor location to a small, lighter-than-air balloon as it moves freely under the influence of air currents. A retroreflective element is attached to the balloon to enhance the optical signal reflected back to the rangefinder. Attitude sensors attached to the rangefinder automatically record the azimuth and altitude angles of the balloon synchronous with the range readings. The recorded data for time, range, and direction are processed by a computer program that calculates the three dimensional (3D) trajectory of the balloon as a function of time.

Optical enhancement of the sensor is accomplished two ways: the preferred embodiment consists of lightweight retroreflectors attached to the balloon to enhance the reflection of the laser pulse back to the rangefinder; the maximum detectable range to the balloon is always enhanced by this method. A second enhancement necessary for nighttime operation is a high intensity light that illuminates the balloon retroeflectors from the ground collinearly with the laser and thereby enhances the balloon's trackability with the automatic tracker. A third enhancement method is the addition of small lights to the balloon payload itself, within the limitations set by lift requirements and intensity requirements of the automatic tracker.

The derivative of the balloon trajectory with respect to time, corrected for the constant vertical drift of the balloon, is an accurate measure of the wind velocity along the trajectory. Thus, evaluation of the 3D trajectory of the balloon yields knowledge of the wind velocity and direction from near the ground up to the maximum height to which the balloon is tracked. The functional dependence of wind vectors vs altitude is commonly known as the wind profile.

Because the balloon drifts horizontally as it rises, evaluation of the trajectory provides information about wind vector variations with respect to horizontal location. Such dependences, combined with the wind profile define the wind vector field. The disclosed method provides for characterization of the wind field by evaluation of multiple balloon trajectories launched at various time intervals according to the needs for useful wind data.

The disclosed wind mapping apparatus and method is inexpensive in both equipment and operation. The apparatus is easily deployable, can provide real time data, is accurate, precise, and portable. The method can be used for the calibration and validation of other remote sensors, and has widespread applicability for prospecting for favorable wind energy sites, identifying optimal locations for wind turbines, and evaluating wind characteristics to support civil and environmental engineering studies.

### BRIEF DESCRIPTION OF THE DRAWINGS

Understanding that drawings depict only certain preferred embodiments of the invention and are therefore not to be considered limiting of its scope, the preferred embodiments will be described and explained with additional specificity and detail through the use of the accompanying drawings in which:

FIG. 1 is a schematic showing the components of the wind mapping system.

FIG. 2 is a schematic of a tracer balloon with an attached retroreflecting target and an enlarged section showing the retroreflector corner cube pattern.

FIG. 3 shows a process flow chart identifying the steps involved in the wind mapping process.

FIG. 4 is an example of the time-stamped positions of a tracer balloon showing the wind trajectory.

FIG. 5 shows graphical examples of analyzed data presented as horizontal wind direction, horizontal wind velocity, and vertical wind shear as a function of altitude.

### DETAILED DESCRIPTION OF SELECTED EMBODIMENTS

In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as represented in the drawings, is not intended to limit the scope of the invention, but is merely representative of the various embodiments of the invention.

Wind field mapping refers to the process of measuring the localized wind at points in space and plotting the velocity information (direction and magnitude) as a function of position. Wind profiles are useful in a variety of applications, such as those previously mentioned. Because of their small mass and size, tracer balloons respond rapidly to wind fluctuations and shear. The tracer balloon motions take place at subcritical Reynolds numbers and thus accurately reflect the essential properties of the local wind flow.

The disclosed small scale wind field mapping method and apparatus is based on the 3-way synergy between small balloons, compact laser rangefinders, and light-weight retroreflectors for purposes of wind characterization.

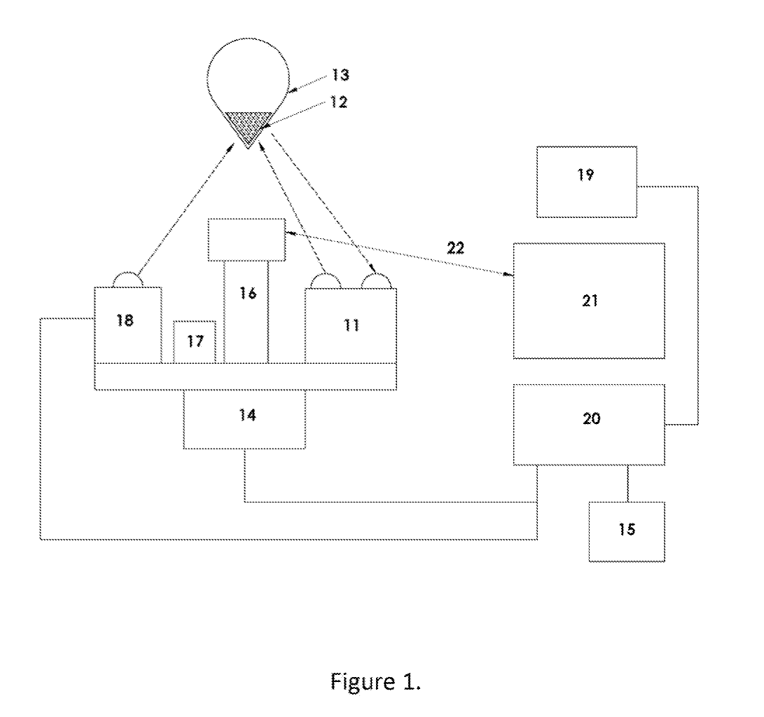

The wind profiling sensor system 10, illustrated in FIG. 1, comprises a miniature laser rangefinder 11, a retroreflecting target 12 attached to a tracer balloon 13, a multi-axis gimbal 14 and joystick 15, a compass 16, an inclinometer 17, video camera 18 and monitor 19, an image recognition device 20, a computer 21, and a wireless link 22.

The miniature laser rangefinder 11 is used to measure the range, or distance, from the rangefinder 11 to the retroreflecting target 12 attached to a tracer balloon 13. A laser rangefinder is a device that sends a laser pulse to a target and measures the time taken by the laser pulse to be reflected from the target back to the rangefinder. The distance to the target is calculated from the measured time of flight. This device is also referred to as an optical time-of-flight rangefinder.

The pointing direction of the rangefinder 11 is a set of direction angles measured by an attitude sensor. In an embodiment, the attitude sensor may be a compass 16 and an inclinometer 17 in which the inclinometer 17 measures the altitude angle and the compass 16 measures the azimuth angle. Other types of attitude sensors, such as fluid stabilized devices, vertical reference units, inertial systems, and the like may be used to measure direction angles. The combination of the laser rangefinder 11, inclinometer 17, and compass 16 provide for the precise measurement of the coordinates (range, altitude angle, and azimuth angle) of the retroreflecting target 12 attached to a tracer balloon 13. In one embodiment, the laser rangefinder is operated at a wavelength of 905 nm and at the appropriate laser power and pulse energy such that it is eyesafe, although other laser power, energy, and wavelengths may be used. Range information is typically measured within 1 m accuracy. The precision of the altitude angle measurement is ±0.1 degree and the azimuth angle precision is ±0.01 degree.

The laser rangefinder 11, compass 16, and inclinometer 17 are programmed to automatically collect and send data to the computer 21 by a wireless link 22 for storage and analysis. Other embodiments may utilize wired communication methods to transfer the collected data to the computer 21 or other known data storage methods to collect the data from the laser rangefinder 11, compass 16, and an inclinometer 17 for later transfer to the computer 21.

The retroreflecting target 12, in one embodiment, is attached to a tracer balloon 13. The tracer balloon 13 may be a common rubber or latex balloon, with a diameter of approximately 25 cm, and filled with helium or some other lighter than air gas. Other similar size lighter than air balloons may be used. Such small balloons have a typical rate of rise of about 2 m/s. The free-floating small balloon trajectories are not disturbed by lift instabilities because the Reynolds number (R˜50,000) is much less than the threshold for lift instability. Note that larger balloons, on the order of 1 meter or greater in diameter, typically have R approaching 1,000,000, which is much larger than the threshold for lift instability, thus if these larger balloons were used, accurate results could not be obtained. The lift instability causes the larger balloons not to advect accurately over small distances, thus making them unsuitable for small scale wind characterization. Historically, larger balloons, such as weather balloons, were tracked by means such as radar for large scale wind characterization.

Without a retroreflector, the maximum range for a compact laser rangefinder to track a small balloon is less than 400 meters. This is insufficient to reliably characterize wind over a test site to altitudes of interest. With a light-weight retroreflector attached to the balloon, the maximum range increases to more than 2 km. This enables reliable target tracking over large wind sites to altitudes far exceeding 500 m.

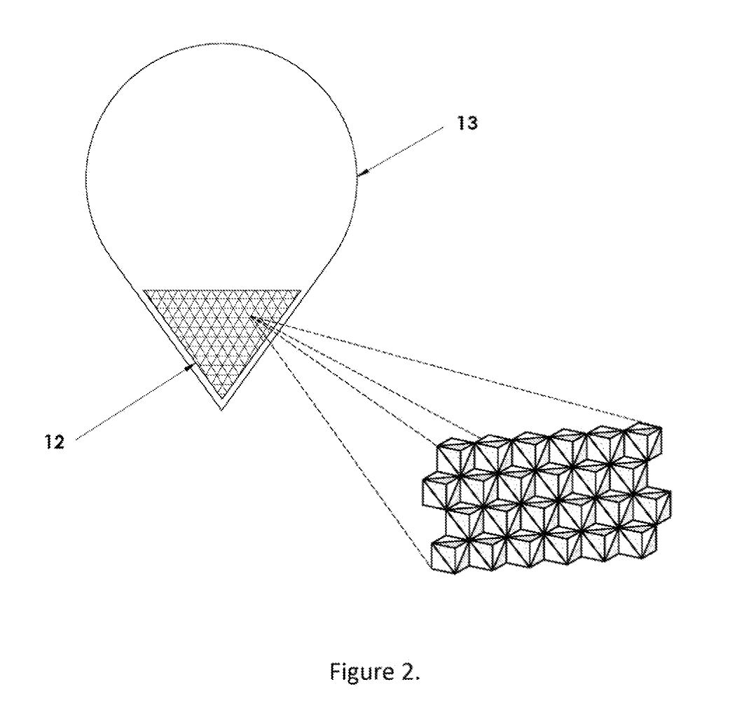

The retroreflecting target 12 is attached to the tracer balloon 13. A retroreflector is a material with properties that reflect light back along the path it came, thus in the direction of the source. Retroreflectors can be solid or hollow corner cube optical structures, glass spheres, or microcorner cube features integrated into the surface of a material. The retroreflecting target 12 for the preferred embodiment consists of multiple pieces of flexible conspicuity tape which are mounted on the bottom of the tracer balloon 13, as shown in FIG. 2, in a conical shape. One example of a retroreflective surface pattern, namely a microcorner cube feature, is shown in an enlarged view of the conspicuity tape shown in FIG. 2. The tape is light enough to be lofted on small balloons. The retroreflector serves multiple purposes in this apparatus. The retroflective properties enhance the optical cross section of the tracer balloon, thus increasing tracking sensitivity and effectively extending the range of the laser rangefinder. Additionally, the retroreflector acts to improve the rangefinder signal discrimination with respect to background objects and scene clutter.

The retroreflecting target and an illuminator allow the wind profiling sensor system to be used at night or during times of law light. The visibility of the retroreflecting target on a tracer balloon during twilight or nighttime is improved with the use of an illuminator. An illuminator is any source of light that can be directionally aimed, and when aimed at the retroreflecting target introduces additional light for the system. The illuminator is mounted on the multi-axis gimbal and aimed in the same direction as the laser rangefinder. Light from the illuminator is retroreflected from the retroreflecting target on the tracer balloon toward the rangefinder, improving the visibility of the target. This facilitates improved tracking, whether manual or automatic. Note that the illuminator may be steady or modulated and its optical spectrum may be broad or narrow.

Referring back to FIG. 1, the laser rangefinder 11, compass 16, inclinometer 17, and video camera 18 are mounted to a motorized multi-axis gimbal 14. The gimbal is a device or platform that can pivot around its different axes such that the orientation can remain fixed relative to a moving object. The motorized multi-axis gimbal 14, video camera 18, and image recognition device 20 are integrated to form an autonomous tracking system. The joystick 15 is used to manually aim the video camera 18 and adjust the magnification of the image. The video camera 18 and laser rangefinder 11 are co-aligned, thus as the autonomous tracking system follows the path of the tracer balloon 13, the laser rangefinder 11 simultaneously follows the path of the retroreflecting target 12 attached to the tracer balloon 13. The multi-axis gimbal 14 allows for smooth movement of the laser rangefinder 11 as it is continuously aimed toward the retroreflecting target 12 attached to the tracer balloon 13 as it drifts with the wind.

The wind profiling sensor system described above may be embodied in other specific forms without departing from its fundamental functions or essential characteristics. For example, the system can be implemented manually without the autonomous tracking functions and the programmed data collection and analysis features. A contrasting example of the wind profiling sensor system is a totally autonomous system including tracer balloon release, motion detection to move the video camera such that the tracer balloon is within its field of view for initiating the image recognition device and autonomous tracking coupled with automatic data measurements and calculations of wind characteristic.

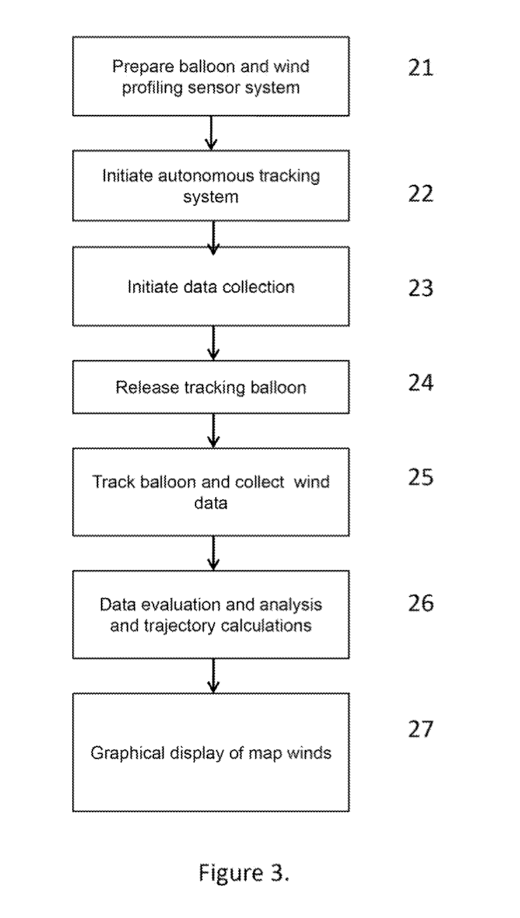

An embodiment describing a method for characterizing small scale wind fields utilizing the above described sensor system is disclosed. The steps of this method for measuring data and generating wind maps are presented in FIG. 3.

The first process step is the preparation of the wind profiling sensor system and the tracer balloon 21. The wind profiling sensor system is set up stably in a location with visibility over the wind characterization site. The tracer balloon is inflated with helium or any other appropriate lighter than air gas. A retroreflective material, preferably a conspicuity tape with microcorner cube features integrated into the surface of a material, is affixed to the bottom of the tracer balloon forming a conical shaped retroreflector. The weight of the retroreflector is small enough that it does not cancel the loft of the balloon.

The next step is initiating the autonomous tracking system 22. This is accomplished by positioning the tracer balloon with the retroreflecting target within the field of view of the video camera. The joystick is used to manually guide the multi-axis gimbal to center the video camera view on the tracer balloon with the retroreflecting target. A joystick trigger command is then sent to the image recognition device to identify the centered image as the target. The image recognition software begins to autonomously track the tracer balloon with the retroreflecting target within the video camera field of view.

The next step is starting the data acquisition system on the computer 23. A signal is sent to the laser rangefinder and attitude sensor across the wireless communication link instructing these devices to begin seeking range and direction angle data from the retroreflecting target attached to a tracer balloon and transmitting the data to the computer. The combination of range and direction angle data is referred to as trajectory data. When an inclinometer and compass are used as components of the attitude sensor, the direction angle data comprises altitude and azimuth angles.

The tracer balloon with the retroreflecting target is then released from a location within or near the wind characterization site so that it drifts over the site within view of the wind profiling sensor system 24.

The next step is autonomously tracking the retroreflective target on the tracer balloon and collecting trajectory data while it floats freely over the wind characterization site and moves as a result of the localized wind forces 25. The image recognition software tracks the tracer balloon with the retroreflecting target within the camera field of view. Target offset date is continuously fed back to the multi-gimbal as an error signal that is used to keep the video camera centered on the target, i.e. the tracer balloon with the retroreflecting target. Because they are optically co-aligned, the laser rangefinder tracks the balloon along with the video camera. The laser rangefinder, inclinometer, and compass deliver range and directional data back to the computer where it is time stamped and stored in a data log. The typical data collection rate is one trajectory point every 3 seconds, although a wide range of data collection times may be used and the period between readings need not be constant. The video camera has an optical zoom which is utilized to track the tracer balloon with the retroreflecting target out to an extended range. The zoom is increased as the apparent balloon size decreases. Data collection continues as long as the autonomous tracking system remains locked on the target and the target remains within range.

The next process step is the evaluation and analysis of the collected trajectory data and the calculation of the trajectory of the tracer balloon 26. Software algorithms have been developed to perform these functions. For each data collection session, the raw data is recorded as a reading, which is defined as a sequence of 4-vectors. Each vector consists of a time-tag, range, altitude angle, and azimuth angle. Between tracer balloon flights, the data file is padded with special values that enable its segmentation into individual data collection sessions corresponding to different tracer balloon flights. Trajectory analysis and wind characterization may be requested for one or more balloon flights without interrupting the data session.

The first task of trajectory analysis is the evaluation of the collected data, (i.e. the sequence of 4-vectors consisting of a time-tag, range, altitude angle, and azimuth angle), to eliminate false or invalid readings. False readings are defined as 4-vectors for which there is no valid range or the measured range does not correspond to the position of the tracer balloon. False readings are identified by the occurrence of invalid range values or by non-physical increments in the range value. Examples of these types of data errors may include range detection failures due to factors such as excessive background scene brightness and false rangefinder readings caused by interference from the background scene or foreground dust particles. Data errors are removed from the data log.

The next task is to transform the valid data points into local Cartesian coordinates or spherical coordinates relative to the position of the wind profiling sensor system. The wind characteristics, namely the vector velocity, horizontal wind speed and direction, and vertical shear are then calculated.

The average velocity and the average direction of motion of the tracer balloon, corresponding to the average velocity and average direction of the measured wind, is obtained by differencing the time (At) and the coordinates (Δx, Δy, and Δz) between each observation. The derived quantities are the velocity components, u=Δx/Δt, v=Δy/Δt, and the horizontal wind speed Vₕₒᵣ=(u²+v²)^{1/2}, The direction D is given by tangent(D)=Δx/Δy in degrees clockwise from north.

In another embodiment, the utility of the trajectory data, for purposes of wind mapping, may be enhanced by smoothing and filtering techniques. A systematic approach to smoothing the trajectory data involves filtering the data by a process such as a Gaussian-weighted Quadratic Least-squares Filter (GQLF) or a locally estimated scatterplot smoothing (LOESS) routine to account for its asynchronous nature and the shortness of the data intervals relative to the resolution employed for the time records. Although the timing of the raw trajectory data may be irregular, the GQLF process produces a regular time sequence of trajectory estimates. At each estimate point, GQLF simultaneously estimates vectors for the tracer balloon location, velocity, and acceleration. At each evaluation time tᵢ, a quadratic least-squares fit of the data to the coordinate values is performed according to the equation

xᵢ=b₀+b₁(tᵢ−t)+½b₂(tᵢ−t)²+ε₃,

with Gaussian weights

wᵢ=exp{−(tᵢ−t)²/2σ²}.

The estimated trajectory vectors x(t) are b₀; b₁ is the tracer balloon velocity component vₓ(t); b₂ is the tracer balloon acceleration aₓ(t). The y and z coordinates are smoothed similarly at a common set of evaluation times. The scale parameter for Gaussian weighting is typically set to σ=10 s which results in effective smoothing of measurement noise with minimal distortion of the tracer balloon trajectory. This method handles the asynchronous rangefinder data and provides estimates at arbitrary evaluation times for the tracer balloon position, velocity, and acceleration.

Wind shear (∂Vₕₒᵣ)/∂z) is estimated using a weighted least squares procedure with z as the independent variable (not t) and Vₕₒᵣ as the dependent variable. This allows for the systematic treatment of shear as an altitude-dependent quantity in spite of vertical reversals of balloon motion that are often observed.

The final step in the process is to graphically display the data as a wind map or to generate tables displaying the wind characteristics or provide the wind characteristics in any other appropriate format that may be viewed to analyze the measured wind characteristics 27. For small target balloons, such as a tracer balloon described in the present disclosure, drag readily overcomes inertia. Consequently the balloon velocity accurately matches the local wind velocity, plus a steady terminal loft velocity. The loft velocity is subtracted from the balloon velocity vectors to derive a set of wind vectors corresponding to points along the balloon trajectory. A vertical wind profile is created by plotting wind velocity information (magnitude and direction) versus trajectory altitude.

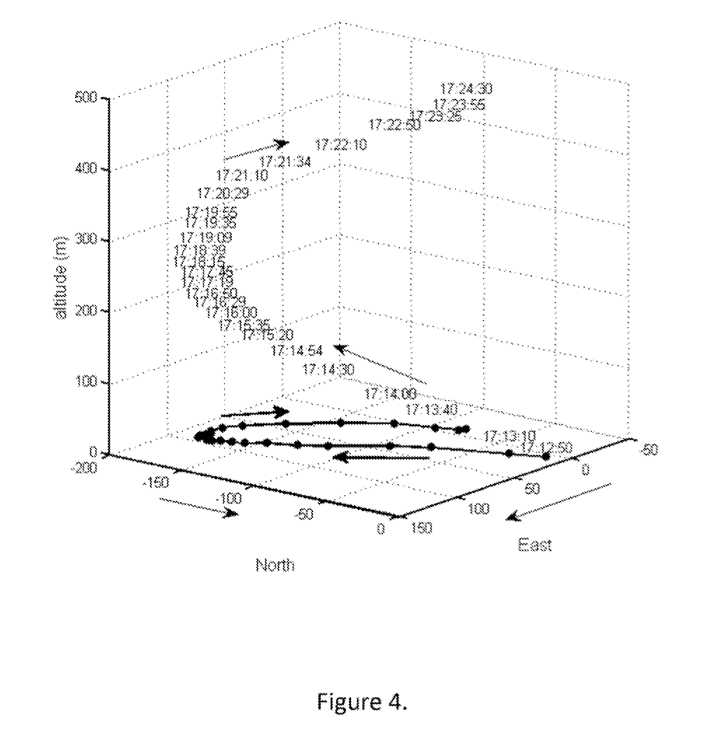

FIG. 4 shows an example of the time-stamped positions of a tracer balloon tracked using the disclosed apparatus and method. The tracer balloon flight was tracked for about 24 minutes up to an altitude of 400 meters, showing a strong change of direction at 200-250 meters from predominantly SE to NW. The wind direction nomenclature adopted in this disclosure states the wind direction in the direction of the tracer balloon motion, rather than the opposite or “from” convention used in meteorology. The time intervals shown on the trajectory correspond to the points on the ground track. The horizontal wind speed here is at most 1.0-1.5 meters/sec, and is minimal near the turn-around altitude.

Wind data from multiple balloon flights may be combined to enhance the accuracy of the wind profiles, to identify changes in the wind profiles, or to create a wind field description that covers a range of locations over the site. Wind field representations may be enhanced by coordinating the wind information with a topographic map of the site, i.e. the ground surface below the balloon trajectories.

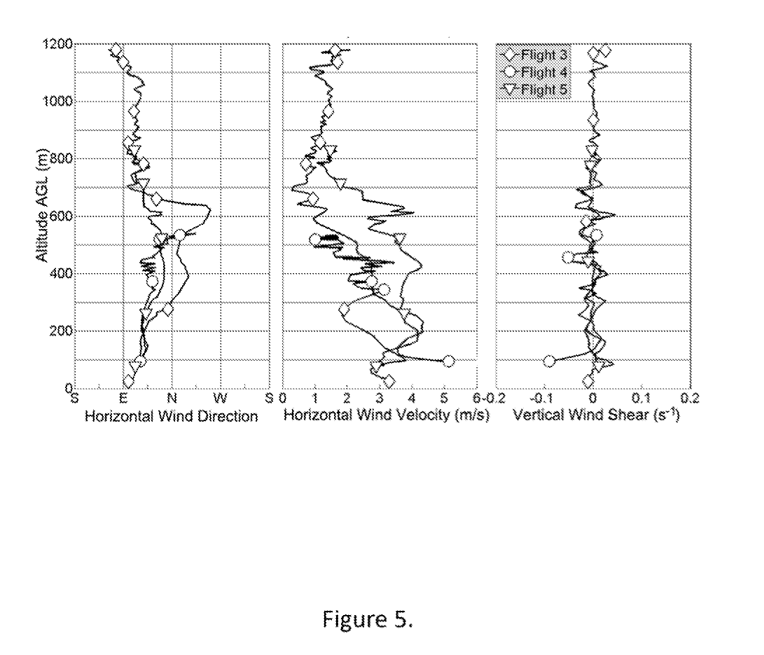

FIG. 5 shows graphical examples of analyzed data presented as horizontal wind direction, horizontal wind velocity, and vertical wind shear as a function of altitude.

Many wind measurement methods suffer from limited accuracy at low wind speeds. By contrast, in the disclosed method the relative accuracy increases at low wind speeds because more trajectory data contribute to each wind velocity determination.

While specific embodiments of the wind profiling sensor system and method have been illustrated and described, it is to be understood that the disclosed invention is not limited to the precise configuration, components, and methods disclosed herein. Various modifications, changes, and variations apparent to those of skill in the art may be made in the arrangement, operation, and details of the device and method of the present invention disclosed herein without departing from the spirit, scope, and underlying principles of the disclosure. For example, some of the process steps may be performed in different sequences without deviating from the scope of the method and equivalent hardware components may be utilized in the apparatus. The described embodiments are to be considered in all respects as illustrative and not restrictive. Therefore, the scope of the invention is indicated by the appended claims, rather than by the foregoing description.

1. An apparatus for measuring wind characteristics comprising:
a laser rangefinder that can be aimed to track a moving target;
a lighter than air balloon that is small enough to avoid lift instabilities as it rises through the atmosphere; and
a retroreflecting target mounted on said balloon.

2. The apparatus of claim 1 further comprising an illuminator adjacent to said rangefinder and aimed in the same direction as said rangefinder.

3. The apparatus of claim 1 further comprising an attitude sensor for measuring the pointing direction of said rangefinder.

4. The apparatus of claim 3 wherein said attitude sensor comprises;
a compass; and
an inclinometer.

5. The apparatus of claim 3 further comprising means for recording measurements from said rangefinder and said attitude sensor with corresponding time tags.

6. The apparatus of claim 5 further comprising a wireless data transfer system.

7. The apparatus of claim 1 further comprising an autonomous tracking system for holding the line of sight of said rangefinder centered on said retroreflecting target mounted on said balloon.

8. The apparatus of claim 7 wherein said autonomous tracking system comprises:
a motorized multi-axis gimbal;
a video camera; and
an image recognition device.

9. An apparatus for tracking a lighter than air balloon rising through the atmosphere comprising:
a retroreflecting target attached to said balloon;
a multi-axis gimbal;
a laser rangefinder mounted on said gimbal; and
an attitude sensor mounted on said gimbal.

10. The apparatus of claim 9 wherein said attitude sensor comprises:
a compass; and
an inclinometer.

11. The apparatus of claim 9 further comprising a means for automatically recording measurements from said rangefinder and said attitude sensor with corresponding time tags.

12. The apparatus of claim 9 further comprising an illuminator mounted on said gimbal and aimed in the same direction as said rangefinder.

13. The apparatus of claim 9 further comprising a video camera on said gimbal co-aligned with said rangefinder.

14. The apparatus of claim 13 further comprising an image recognition device wherein communication between said multi-axis gimbal, said video camera, and said image recognition device enable an autonomous tracking system to hold the line of sight of said rangefinder centered on said retroreflecting target.

15. A method for measuring wind characteristics comprising:
preparing a lighter than air tracer balloon that is appropriately sized to avoid lift instabilities as it rises through the atmosphere;
attaching a retroreflecting target to said tracer balloon;
releasing said tracer balloon such that it rises freely, advected with the local wind;
tracking said retroreflecting target attached to said tracer balloon using an optical time-of-flight rangefinder and an attitude sensor;
measuring, recording, and time tagging range and direction angle data for points along the trajectory of said tracer balloon; and
analyzing said time tagged range and direction angle data; and
calculating the wind characteristics.

16. The method of claim 15 wherein said direction angle data comprises altitude angle and azimuth angle.

17. The method of claim 15 wherein said wind characteristics are selected from the group consisting of horizontal wind speed, horizontal wind direction, and vertical shear.

18. The method of claim 15 wherein said measuring, recording, and time tagging functions are automatically controlled and performed by a computer.

19. The method of claim 15 further comprising coordinating said wind characteristics with a topographic map of the terrain below the trajectory of said tracer balloon.

20. The method of claim 15 wherein said tracking of said retroreflecting target attached to said tracer balloon is accomplished with the aid of an autonomous tracking system.

21. The method of claim 20 wherein said autonomous tracking system is initiated by positioning said tracer balloon with said retroreflecting target in the field of view of a video camera co-aligned with said rangefinder and sending the image to the image recognition device as the target to track.

22. The method of claim 21 wherein:
the wind profiling sensor system is autonomously configured;
said tracer balloon is released by an automatic balloon release system; and
an automatic motion detection system responds to the movement of said balloon resulting in the initiation of said autonomous tracking system such that measuring small-scale wind characteristics may be accomplished unattended.

23. The method of claim 15 wherein analyzing said time tagged range and said direction angle data comprises eliminating false data.

24. The method of claim 23 wherein analyzing said time tagged range and said direction angle data further comprises transforming valid data to position coordinates and calculating a said wind characteristic selected from the group consisting of horizontal wind speed, horizontal wind direction, and vertical shear.

25. A method for measuring wind characteristics comprising:
mounting a laser rangefinder and attitude sensor on a multi-axis gimbal;
mounting a retroreflecting target on a lighter than air tracer balloon that is appropriately sized to avoid lift instabilities as it rises through the atmosphere;
adjusting the orientation of said gimbal such that said retroreflecting target on said tracer balloon is within the field of view of said rangefinder;
releasing said tracer balloon such that it rises freely, advected with the local wind;
adjusting the orientation of said gimbal to track said tracer balloon such that said retroflecting target remains within the field of view of said rangefinder;
measuring, recording, and time tagging position data of said retroreflecting target at points along the trajectory of said tracer balloon wherein said position data includes;
range data measured using said rangefinder; and
direction angles measured using said attitude sensor; and
calculating the wind characteristics from said time and position data.

26. The method of claim 25 wherein adjusting the orientation of said gimbal to track said tracer balloon is accomplished with the aid of an autonomous tracking system comprising:
a video camera mounted on said gimbal and coaligned with said rangefinder; and
a computer controlled image recognition device.

27. The method of claim 26 wherein said autonomous tracking system is initiated by positioning said tracer balloon with said retroreflecting target in the field of view of a video camera and sending the image to the image recognition device as the target to track.

28. The method of claim 25 wherein said recording of said time tagged range data and said direction data is accomplished by sending said data to a computer.

29. The method of claim 28 wherein sending said data to a computer is performed via a wireless communication link.

30. The method of claim 25 wherein calculating said wind characteristics comprises:
analyzing said time tagged position data to determine false and valid readings;
eliminating said false readings;
transforming said valid data into position coordinates;
smoothing said position coordinates;
calculating vectors at each said time tagged position along said trajectory of said tracer balloon for said retroreflecting target by a quadratic least squares fit equation such as
x₁yᵢzᵢ=b₀+b₁(tᵢ−t)+½b₂(tᵢ−t)²+ε₃
wherein the coefficients
bₒ is the x, y, or z trajectory vector;
b₁ is the x, y, or z velocity component; and
b₂ is the x, y, or z acceleration,
by which the horizontal wind speed, horizontal wind direction, and vertical shear are determined.
